(19) United States
(12) Patent Application Publication
(10) Pub. No.: US 2022/0346416 A1
(43) Pub. Date: Nov. 3, 2022

(54) LOW-CALORIE WHIPPABLE OIL-IN-WATER EMULSIONS CONTAINING NON-NUTRITIVE NATURAL SWEETENERS

(71) Applicant: Rich Products Corporation, Buffalo, NY (US)

(72) Inventors: Shri Sharma, Amherst, NY (US); Mark Frydrychowski, Cheektowaga, NY (US); Sarah Johnson, Akron, NY (US)

(21) Appl. No.: 17/727,507

(22) Filed: Apr. 22, 2022

Related U.S. Application Data
(60) Provisional application No. 63/178,724, filed on Apr. 23, 2021.

(51) Int. Cl. A23L 9/20; A23D 7/00

(52) U.S. Cl. CPC A23L 9/22; A23D 7/003; A23V 2002/00

(57) ABSTRACT

Disclosed herein are low-calorie whippable emulsions. In particular, described herein is a low-calorie whippable oil-in-water emulsion containing a non-nutritive natural sweetener as a replacement for nutritive sweeteners. The whippable emulsions have desirable texture characteristics, organoleptic properties, and stability.

### CROSS-REFERENCE TO RELATED APPLICATIONS

This application claims priority to U.S. Provisional Patent Application No. 63/178,724, filed Apr. 23, 2021, which is incorporated herein by reference in its entirety.

### FIELD

This disclosure relates to low-calorie whippable emulsions. In particular, described herein is a low-calorie whippable oil-in-water emulsion containing a non-nutritive natural sweetener as a replacement for nutritive sweeteners. The whippable emulsions have desirable texture characteristics, organoleptic properties, and stability.

### INTRODUCTION

Whippable food products are commonly used as toppings, icings, fillings, and the like for application to desserts, beverages, and other types of food products. Non-dairy whippable food products have become popular because they have a similar taste to dairy whippable food products but have a longer shelf life than dairy products. Most non-dairy whippable food products are made of vegetable fat and have a high sugar content. The nutritive sweeteners used in whippable food products typically are high fructose corn syrup, granulated sugar, sugar alcohols and other carbohydrates derived from corn solids, all of which are avoided by health-conscious consumers. Currently available whippable food products are high in calories and are high glycemic index foods. Therefore, these whippable food products are not suitable for people with type 1 or type 2 diabetes, or people with sensitivities to sugar such as sugar intolerance. Further, some government bodies are charging a sugar tax on food products with high sugar contents due to the obesity epidemic and prevalence of diabetes among young children and adults.

To address these problems, alternatives to nutritive sweeteners such as artificial or natural high intensity sweeteners have been used. However, these high intensity sweeteners have an undesirable bitter or metallic taste that is present in the final food product. Moreover, small quantities of these sweeteners are used to replace nutritive sweeteners and therefore, they lack the ability to act as bulking agents or provide textural characteristics to desserts and other food products. Consumer selection of a whippable food product also depends on the mouthfeel and taste of the whipped food product.

Therefore, there is a need for a low-calorie whipped food product that is stable and provides desirable organoleptic properties such as a conventional taste, flavor, and texture characteristics.

### SUMMARY

In an aspect, the disclosure relates to a whippable emulsion comprising: a non-nutritive natural sweetener; and, a fat. In an embodiment, the non-nutritive natural sweetener comprises allulose, tagatose, or a combination thereof. In another embodiment, the emulsion further comprises water, a stabilizer, an emulsifier, salt, a protein, and a nutritive sweetener. In another embodiment, the emulsion comprises at least about 30 wt % allulose. In another embodiment, the emulsion comprises from about 10 to about 30 wt % of the fat. In another embodiment, the fat is a non-hydrogenated oil, a hydrogenated oil, or a combination thereof. In another embodiment, the non-hydrogenated oil and the hydrogenated oil are vegetable oils. In another embodiment, the vegetable oil is palm kernel oil, palm oil, coconut oil, soybean, canola, nut butter fat, corn oil, or a combination thereof. In another embodiment, the emulsion comprises from about 40 to about 55 wt % water. In another embodiment, the emulsion comprises from about 0.05 to about 0.8 wt % of the stabilizer. In another embodiment, the stabilizer is selected from a group consisting of xantham gum, Methocel™ 50/50, and a combination thereof. In another embodiment, the emulsion comprises from about 0.1 to about 2 wt % of the protein. In another embodiment, the protein is sodium caseinate. In another embodiment, the emulsion comprises less than about 20% of the nutritive sweetener. In another embodiment, the nutritive sweetener is selected from the group consisting of granulated sugar, high-fructose corn syrup, corn syrup, lactose, maltose, sugar alcohol, sucrose, fructose, and dextrose. In another embodiment, the emulsion further comprises a sweetness inhibitor. In another embodiment, the emulsion further comprises a flavoring agent. In another embodiment, the emulsion further comprises a coloring agent.

In a further aspect, the disclosure relates to a whippable emulsion comprising: at least about 30 wt % of a non-nutritive natural sweetener; from about 10 to about 25 wt % fat; from about 40 to about 55 wt % water; from about 0.05 to about 0.8 wt % stabilizer; from about 0.1 to about 2 wt % protein; less than about 10% of a nutritive sweetener; an emulsifier; salt; a sweetness inhibitor; and, a flavoring agent.

Another aspect of the disclosure provides a method for making a whipped food product comprising: (a) mixing a nutritive sweetener and one or more of sodium caseinate, methocel, salt, dipotassium hydrogen phosphate, xanthan gum, and rice extract; (b) adding the mixture of (a) to a fat and mixing; (c) adding from about 165° F. to about 170° F. water and a non-nutritive natural sweetener to the mixture of (b) and heating the mixture; (d) homogenizing the mixture of (c) to form an emulsion; (e) cooling the emulsion of (d); and, (g) whipping the emulsion of (e) to form a whipped food product. In an embodiment, the mixture of (c) is heated to about 165° F. In another embodiment, the mixture is homogenized in one step or two steps. In another embodiment, the mixture is homogenized at 6,500 PSI and then 500 PSI. In another embodiment, the mixture is homogenized at 7,000 PSI. In another embodiment, the emulsion comprises: at least about 30 wt % of a non-nutritive natural sweetener; from about 10 to about 25 wt % fat; from about 40 to about 55 wt % water; from about 0.05 to about 0.8 wt % stabilizer; from about 0.1 to about 2 wt % protein; less than about 10% of a nutritive sweetener; an emulsifier; salt; a sweetness inhibitor; and, a flavoring agent. In another embodiment, the emulsion is an oil-in-water emulsion.

The disclosure provides for other aspects and embodiments that will be apparent in light of the following detailed description and accompanying figures.

### BRIEF DESCRIPTION OF THE DRAWINGS

FIG. 1 shows the particle size distribution for Samples 26A, 26B and 26C in liquid emulsions. Sample 26A is a topping made with non-hydrogenated oil and allulose sugar; Sample 26B is a topping made with non-hydrogenated oil and granulated sugar; Sample 26C is a topping made with non-hydrogenated oil and high fructose corn syrup.

FIG. 2 shows the particle size distribution for Samples 28A, 28B, 28C, and 28D in liquid emulsions. Sample 28A is a topping made with non-hydrogenated oil and allulose sugar; Sample 28B is a topping made with non-hydrogenated oil and granulated sugar; Sample 28C is a topping made with hydrogenated oil and granulated sugar; Sample 28D is a topping made with hydrogenated oil and granulated sugar.

FIG. 3 shows images of rosette testing for Samples 1187-24A (control), 1213-A, 1213-B, and 1213-C. FIG. 3A shows Sample 1187-24A, FIG. 3B shows Sample 1213-A, FIG. 3C shows Sample 1213-B, and FIG. 3D shows Sample 1213-C.

FIG. 4 shows images of bowl stability testing for Samples 1187-24A (CONTROL), 1213-A (SAMPLE A), 1213-B (SAMPLE B), and 1213-C(SAMPLE C). FIG. 4A shows images of bowls at 72 hours, 5 days, 10 days, 14 days, and 21 days. FIG. 4B shows images of bowls at 35 days.

FIG. 5 shows images of cake stability testing for Samples 1187-24A (CONTROL), 1213-A (SAMPLE A), 1213-B (SAMPLE B), and 1213-C(SAMPLE C). FIG. 5A shows images of cakes for each sample at 0 hours, 48 hours, 72 hours, 5 days, 10 days, and 14 days. FIG. 5B shows cross-sectional images of cakes at day 14.

### DETAILED DESCRIPTION

Described herein are whippable compositions that include a non-nutritive natural sweetener, wherein the non-nutritive natural sweetener may be allulose, tagatose, or a combination thereof. Allulose and/or tagatose can partially or fully replace nutritive sweeteners such as granulated sugar, high-fructose corn syrup, sugar alcohol, and other carbohydrates derived from corn solids. Allulose is a low-calorie sugar which is found in fruit such as raisins, figs, kiwis and jack fruit. Tagatose is a low-calorie sugar which is found in small amounts in dairy products, fruits, and cacao. Allulose and tagatose contain less than 10% and 38% of the calories of sucrose, respectively, yet have a taste and mouthfeel similar to that of granulated sugar. Allulose and tagatose are recognized and absorbed by the body as a simple sugar; however, allulose is not metabolized by the human body and tagatose is primarily metabolized by the liver. Neither allulose nor tagatose impact a person's blood glucose level and are not considered “added sugar”. This disclosure provides a low-calorie whippable composition that has a low glycemic index for consumers with diabetic restrictions and sugar intolerance.

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and,” and “the” include plural references unless the context clearly dictates otherwise. The present disclosure also contemplates other embodiments “comprising,” “consisting of,” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9; for the range from 6 to 9, the numbers 7 and 8 are contemplated in addition to 6 and 9; and for the range 6.0-7.0, the number 6.0, 6.1, 6.2, 6.3, 6.4, 6.5, 6.6, 6.7, 6.8, 6.9, and 7.0 are explicitly contemplated.

The term “about” or “approximately” as used herein as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In certain aspects, the term “about” refers to a range of values that fall within 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). Alternatively, “about” can mean within 3 or more than 3 standard deviations, per the practice in the art. Alternatively, such as with respect to biological systems or processes, the term “about” can mean within an order of magnitude, preferably within 5-fold, and more preferably within 2-fold, of a value.

The term “allulose” (or “D-allulose”) as used herein refers to a monosaccharide sugar that is a six-carbon ketose and epimer of fructose. The molecular formula is C₆H₁₂O₆ and the relative molecular weight is 180.16 g/mol. There are two forms of left-handed and right-handed bodies, dextral D-allulose is typically used as a non-nutritive natural sweetener. Allulose is a white crystalline powder, with about 70% sweetness of the same amount of sucrose. The caloric value of allulose in humans is about 0.2 to 0.4 kcal/g relative to about 4 kcal/g for typical carbohydrates. The melting point of allulose is about 110° C., allulose is soluble in water (e.g., 291% solubility in 25° C. water). Allulose has thermal stability, has a glass transition temperature of −6.5° C., is more hygroscopic than sucrose, has strong acid resistance, and is stable in the pH range of 3.0-7.0. It is also known as “D-psicose” and is a C3 epimer of D-fructose. Its structure is shown below in Formula I:

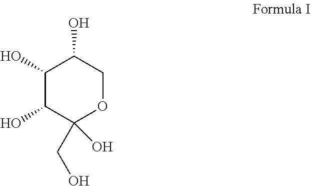 [SMILES: OCC1(O)OC[C@@H](O)[C@@H](O)[C@H]1O]

The term “artificial sweetener” as used herein refers to a synthetic sweetener that does not occur in a plant from which it is manufactured (i.e. not directly isolated or extracted from a plant). In particular, an artificial sweetener is a sweetener that is not found in nature and is synthetically produced.

The terms “high-potency sweetener” or “high-intensity sweetener” refers to a sweetener that has a sweetness many times that of sucrose, such that only very small amounts are needed to provide an equivalent level of sweetness to that of the nutritive sweetener being replaced.

The term “natural sweetener” as used herein refers to any sweetener derived from a natural source such as a plant. Natural sweeteners can be manufactured artificially and produced more economically, with greater purity and more consistent quality, than their natural counterparts. A natural sweetener may be processed and refined to the extent that the processing and refining do not affect the natural character of the sweetener.

The term “non-nutritive sweetener” as used herein refers to a zero- or low-calorie alternatives to nutritive sweeteners. A non-nutritive sweetener relates to a substance having a sweetness equivalent (by weight) of 50% of that of sucrose or greater, and the term “low-calorie sweetener” as used herein relates to a sweetener supplying 70% or less of the calories of a sweet-equivalent amount of sucrose, about 60% or less of the calories of a sweet-equivalent amount of sucrose, about 50% or less of the calories of a sweet-equivalent amount of sucrose, about 40% or less of the calories of a sweet-equivalent amount of sucrose, about 30% or less of the calories of a sweet-equivalent amount of sucrose, about 20% or less of the calories of a sweet-equivalent amount of sucrose, about 10% or less of the calories of a sweet-equivalent amount of sucrose, or about 5% or less of the calories of a sweet-equivalent amount of sucrose. Non-nutritive sweeteners are much sweeter than sugar so only small amounts are needed. Non-nutritive sweeteners provide fewer calories per gram than sugar because they are not completely absorbed by the digestive system and therefore many non-nutritive sweeteners are “non-caloric sweeteners” or “non-caloric sugars” because they are not metabolized. Non-nutritive sugars include artificial sweeteners, natural sweeteners, and the like.

The term “nutritive sweetener” as used herein refers to a “caloric sugar” or “caloric sweetener” such as sucrose (generally referred to as “sugar” or “table sugar”), glucose, fructose, corn syrup, high fructose corn syrup, other carbohydrates derived from corn solids, and the like. Nutritive sweeteners supply not only sweetness to food products, but also bulk, texture, and desirable functional properties such as browning, humectancy, freezing point depression, and the like. They also produce a favorable sensory response, for example in terms of quality of sweetness, lack of bitterness and off taste, desirable temporal profile, and desirable mouthfeel.

The term “tagatose” (or “D-tagatose”) as used herein refers to a six-carbon ketose, a differential isomer of fructose. The molecular formula is C₆H₁₂O₆ and the relative molecular weight is 180.16 g/mol. There are two forms of left-handed and right-handed bodies, dextral D-tagatose is typically used as a non-nutritive natural sweetener. Tagatose is a white odorless crystalline powder, with 92% sweetness of the same amount of sucrose. The caloric value of tagatose in humans is about 1.5 kcal/g relative to about 4 kcal/g for typical carbohydrates. The melting point of tagatose is 132-135° C. and tagatose is soluble in water (e.g., 62% solubility in 30° C. water). Tagatose has thermal stability, a glass transition temperature of 15° C., easy crystallization, low hygroscopicity, strong acid resistance, and is stable in the pH range of 2.0-7.0. Its structure is shown below in Formula II:

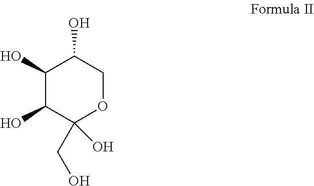 [SMILES: OCC1(O)OC[C@@H](O)[C@H](O)[C@@H]1O]

Unless otherwise defined herein, scientific and technical terms used in connection with the present disclosure shall have the meanings that are commonly understood by those of ordinary skill in the art. For example, any nomenclatures used in connection with, and techniques of, molecular biology, microbiology, and food science described herein are those that are well known and commonly used in the art. The meaning and scope of the terms should be clear; in the event however of any latent ambiguity, definitions provided herein take precedent over any dictionary or extrinsic definition. Further, unless otherwise required by context, singular terms shall include pluralities and plural terms shall include the singular.

### 2. Whippable Emulsion

Provided herein are whippable emulsions comprising a sweetener, wherein the sweetener may contain a non-nutritive natural sweetener such as allulose, tagatose, or a combination thereof. In an embodiment, the whippable emulsion may comprise allulose, a nutritive sweetener, a fat, water, a stabilizer, an emulsifier, salt, and a protein. In an embodiment, the whippable emulsion may comprise tagatose, a nutritive sweetener, a fat, water, a stabilizer, an emulsifier, salt, and a protein. In an embodiment, the whippable emulsion may comprise allulose and tagatose, a nutritive sweetener, a fat, water, a stabilizer, an emulsifier, salt, and a protein. In another embodiment, the whippable emulsion may also comprise a sweetness inhibitor. In another embodiment, the whippable emulsion may further comprise a flavoring agent. In another embodiment, the whippable emulsion may comprise a coloring agent.

Sweeteners may make up from about 20 to about 60 weight percent (wt %) of a whippable emulsion described herein. The whippable emulsion may comprise from about 20 to about 55 wt %, from about 20 to about 50 wt %, from about 20 to about 45 wt %, from about 20 to about 40 wt %, from about 20 to about 35 wt %, from about 20 to about 30 wt %, from about 20 to about 25 wt %, from about 25 to about 60 wt %, from about 30 to about 60 wt %, from about 35 to about 60 wt %, from about 40 to about 60 wt %, from about 45 to about 60 wt %, from about 50 to about 60 wt %, or from about 55 to about 60 wt % sweeteners. In one non to about limiting embodiment, the whippable emulsion contains from about 22 to about 31 wt % sweeteners.

a. Nutritive Sweeteners

Various types of nutritive sweeteners (i.e. caloric sugars) can be used in whippable emulsions, including granulated sugar from cane or sugar beet, modified sugars such as high-fructose corn syrup, corn syrup, refiners syrup, caramel, inverted sugar and golden syrup, sucrose, fructose, glucose, dextrose, galactose, trehalose, lactose, maltose, natural caloric sugars such as honey, maple syrup, coconut palm sugar and sorghum syrup, and other carbohydrates derived from corn solids.

Nutritive sweeteners have multiple functional roles in the finished food products and supply not only sweetness to food products, but also bulk (e.g., act as bulking agents to impart high viscosity and texture), texture, and desirable functional properties such as browning, humectancy (e.g., controls water activity), freezing point depression, helps maintain the freeze-thaw stability of a finished product, and the like. They also produce a favorable sensory response, for example in terms of quality of sweetness (sweet taste and flavor), lack of bitterness and off taste, desirable temporal profile, and desirable mouthfeel.

b. Non-Nutritive Sweeteners

One of the major challenges is the development of whipped toppings and fillings for health-conscious consumers who desire to restrict sugar and high calorie intake. Zero- or low-calorie alternatives to nutritive sweeteners are desired. Various types of non-nutritive sweeteners can be used in a whippable emulsion as described herein. Non-nutritive sweeteners provide a sweet taste without supplying calories or carbohydrates. Some “low-calorie sweeteners” are “nutritive,” but due to their intense sweetness (they are sometimes referred to as “intense sweeteners” or “high intensity sweeteners”) the amounts needed to achieve the desired sweetness are so small that they are considered virtually non-caloric. Non-nutritive sweeteners can be used for baking. Non-nutritive sweeteners provide fewer calories per gram than sugar because they are not completely absorbed by the digestive system and therefore are non-caloric sweeteners or non-caloric sugars.

The whippable emulsion may comprise no nutritive sweeteners, less than about 1 wt %, less than about 5 wt %, less than about 10 wt %, less than about 15 wt %, less than about 20 wt %, less than about 25 wt %, less than about 30 wt %, less than about 35 wt %, or less than about 40 wt % of a nutritive sweetener. The whippable emulsion may comprise from about 0 to about 40 wt %, from about 1 to about 40 wt %, from about 5 to about 40 wt %, from about 10 to about 40 wt %, from about 15 to about 40 wt %, from about 20 to about 40 wt %, from about 25 to about 40 wt %, from about 30 to about 40 wt %, from about 35 to about 40 wt %, from about 0 to about 35 wt %, from about 1 to about 35 wt %, from about 5 to about 35 wt %, from about 10 to about 35 wt %, from about 0 to about 30 wt %, from about 1 to about 30 wt %, from about 5 to about 30 wt %, from about 10 to about 30 wt %, from about 0 to about 25 wt %, from about 1 to about 25 wt %, from about 5 to about 25 wt %, from about 10 to about 25 wt %, from about 0 to about 20 wt %, from about 1 to about 20 wt %, from about 5 to about 20 wt %, from about 10 to about 20 wt %, from about 0 to about 15 wt %, from about 1 to about 15 wt %, from about 5 to about 15 wt %, from about 10 to about 15 wt %, from about 0 to about 10 wt %, from about 1 to about 10 wt %, from about 5 to about 10 wt %, from about 0 to about 5 wt %, from about 1 to about 5 wt %, or from about 0 to about 1 wt % of a nutritive sweetener.

i) Non-Nutritive Artificial Sweeteners

Non-nutritive artificial sweeteners are often used to reduce or replace the nutritive sweetener content in food products. Non-nutritive artificial sweeteners can be high-potency sweeteners such as saccharin, acesulfame potassium, aspartame, neotame, advantame, cyclamate, sucralose, and the like.

Non-nutritive artificial sweeteners typically require the addition of a bulking agent (for example, a non-sweet saccharide polymer such as maltodextrin), and generally fail to provide the same taste and functional properties as the nutritive sweetener being replaced. For example, they often leave an unpleasant metallic or bitter aftertaste, result in poor textural properties, and result in poor freeze-thaw stability of a finished product.

ii) Non-Nutritive Natural Sweeteners

A non-nutritive natural sweetener may be a “sugar alcohol” or “polyol” (for example, erythritol, xylitol, sorbitol, maltitol, mannitol, lactitol, isomalt, lactitol, glycerol, hydrogenated starch hydrolysates (HSH), etc.). Polyols are carbohydrates and occur naturally in small amounts in plants and cereals. They typically contain fewer calories per gram than sugar because they are not fully metabolized and do not cause tooth decay. These sweeteners are generally able to provide a degree of calorie reduction (by way of example, sorbitol provides about 2.6 kcal/g compared to about 4 kcal/g for sucrose) while also providing bulk. Polyols are unable to fully mimic desired taste characteristics (they often produce a perceived cooling sensation) or functional properties (such as browning). Furthermore, polyols are often not suitable for use at high levels due to low gastro-intestinal tolerance.

Non-nutritive natural sweeteners also include high-intensity natural sweeteners such as stevia (i.e. steviosides), monk fruit (i.e. mogrosides; luo han guo), thaumatin, pentadin, monatins, monellin, brazzein, miracle fruit (i.e. miraculin), glycyrrhizin, curculin, mabinlins, and the like. High-intensity natural sweeteners are similar to high-intensity artificial sweeteners in that they typically require the addition of a bulking agent, and generally fail to provide the same taste and functional properties as the nutritive sweetener being replaced. For example, they often leave an unpleasant metallic or bitter aftertaste, result in poor textural properties, and result in poor freeze-thaw stability of a finished product.

In addition, non-nutritive natural sweeteners include natural carbohydrates (e.g., sugars) such as D-psicose/D-allulose (i.e. allulose), D-tagatose (i.e. tagatose), L-sorbose, allose, apiose, and the like. Natural sugars are mostly of plant, animal, and microbe origin. Natural sugars are sugars that occur in limited quantities in nature and can be made, for example, using enzymes in a process called Izumoring.

A non-nutritive natural sweetener that is useful in the emulsion disclosed herein is allulose. Allulose is known as a “rare sugar” because it occurs in nature in only very small amounts. It provides about 70% of the sweetness of sucrose, but only about 5% of the calories (approximately 0.2 kcal/g). It may therefore essentially be considered to be a “zero calorie” or “low calorie” sweetener. In view of its scarcity in nature, production of allulose relies on the epimerization of readily available fructose. Ketose-3-epimerases can interconvert fructose and allulose, and various ketose-3-epimerases are known for carrying out this conversion.

U.S. Pat. No. 8,030,035 and PCT publication no. WO2011/040708 disclose that D-psicose (i.e. allulose) can be produced by reacting D-fructose with a protein derived from Agrobacterium tumefaciens and having psicose 3-epimerase activity. US patent publication no. 2011/0275138 discloses a ketose 3-epimerase derived from a microorganism of the Rhizobium genus and a process for producing ketoses by using the protein. This protein shows a high specificity to D- or L-ketopentose and D- or L-ketohexose, and especially to D-fructose and D-psicose. Korean patent no. 100832339 discloses a Sinorhizobium YB-58 strain which can convert fructose into psicose (i.e. allulose), and a method of producing psicose using a fungus body of the Sinorhizobium YB-58 strain. Korean patent application no. 1020090098938 discloses a method of producing psicose using E. coli wherein the E. coli expresses a polynucleotide encoding a psicose 3-epimerase.

Another non-nutritive natural sweetener that is useful in the emulsion disclosed herein is tagatose. Tagatose is often found in low amounts in dairy products (e.g., yogurt, milk powder, and other dairy products), fruits (e.g., apples, oranges, and pineapple) and cacao, and has a very similar texture to sucrose (table sugar). It provides about 92% as sweet as sucrose, but has only 38% of the calories of sucrose. It may therefore essentially be considered to be a “zero calorie” or “low calorie” sweetener. In view of its scarcity in nature, production of tagatose relies on the hydrolysis and isomerization of readily available lactose and galactose. Starting with lactose, which is hydrolyzed to glucose and galactose, tagatose can then be produced from the resulting galactose. The galactose is isomerized under alkaline conditions to D-tagatose by calcium hydroxide.

Unlike many known replacements for nutritive sweeteners (such as natural and artificial high intensity sweeteners, sugar alcohols, and the like), it has been found that allulose and tagatose are able to be used at high levels to effectively mimic the desirable taste characteristics and functional properties of caloric sweeteners, without the need for other components such as bulking agents, temporal profile modifiers, flavor enhancers, and the like. In particular, it has been found that high levels of allulose and tagatose are able to provide bulking and texture, desirable functional properties such as browning (e.g., Maillard browning reaction), caramelization, humectancy, freezing point depression, and the like. Allulose and tagatose also provide a favorable sensory response, for example in terms of quality of sweetness, lack of bitterness and off taste, desirable temporal profile, and desirable mouthfeel. It has also been found that allulose and tagatose are able to offer processing benefits by acting as, for example, an aeration modifier, stabilizer, extrusion aid, melt control agent, fermentation performance enhancer, selective culture nutrient source, modifier of starch gelatinization temperature, osmotic pressure modifier, water activity depressant, freezing point depressant, rheology modifier, foam stabilizer, recrystallization control agent, fat crystal control agent, color development aid, compression aid, and the like.

Allulose, tagatose, or a combination thereof can constitute all or a portion of the sweetener in the whippable emulsion described herein. Allulose sugar was surprisingly found to function similarly to cane sugar over a wide range of product applications in the whippable emulsions described herein, and was also surprisingly found to work in synergy with other sugars and sweeteners to create a low-calorie, cost-effective sweetener system in a whippable emulsion. Allulose was found to provide a similar taste and perform a similar function in the whippable emulsion described herein as compared to whippable compositions/emulsions which contain only a caloric sugar such as granulated sugar or high-fructose corn syrup.

Allulose, tagatose, or the combination thereof, may be in any of the following forms: granulated, powdered, syrup, or liquid form.

The whippable emulsion may comprise at least about 5 wt %, at least about 10 wt %, at least about 15 wt %, at least about 20 wt %, at least about 25 wt %, at least about 30 wt %, at least about 35 wt %, at least about 40 wt %, at least about 45 wt %, at least about 50 wt %, at least about 55 wt %, or at least about 60 wt % allulose, tagatose, or a combination thereof. The whippable emulsion may comprise from about 5 to about 60 wt %, from about 10 to about 60 wt %, from about 15 to about 60 wt %, from about 20 to about 60 wt %, from about 25 to about 60 wt %, from about 30 to about 60 wt %, from about 35 to about 60 wt %, from about 40 to about 60 wt %, from about 45 to about 60 wt %, from about 50 to about 60 wt %, from about 55 to about 60 wt %, from about 5 to about 55 wt %, from about 5 to about 50 wt %, from about 5 to about 45 wt %, from about 5 to about 40 wt %, from about 5 to about 35 wt %, from about 5 to about 30 wt %, from about 5 to about 25 wt %, from about 5 to about 20 wt %, from about 5 to about 15 wt %, or from about 5 to about 10 wt % allulose, tagatose, or a combination thereof.

One or more sweeteners other than allulose, tagatose, or a combination thereof can be included in a whippable emulsion described herein. If one or more other sweeteners are used, such sweeteners can be added as bulking agents to provide additional solids and provide body to the foam structure of the whippable emulsion described herein. Generally, the sweetener includes from about 10 to about 100 wt % allulose, tagatose, or a combination thereof, typically from about 40 to about 100 wt % allulose, tagatose, or a combination thereof, more typically from about 60 to about 100 wt % allulose, tagatose, or a combination thereof, and even more typically from about 90 to about 100 wt % allulose, tagatose, or a combination thereof.

When the whippable emulsion comprises allulose, tagatose, or a combination thereof, the whippable emulsion contains about 30%, about 35%, about 40%, about 45%, about 50%, about 55%, about 60%, about 65%, about 70%, about 75%, or about 80% fewer calories than a whippable composition/emulsion containing a nutritive sweetener. When the whippable emulsion comprises allulose, tagatose, or a combination thereof, the whippable emulsion has a low glycemic index as compared to a whippable composition/emulsion containing a nutritive sweetener.

c. Fats

A fat that can be used in a whippable emulsion described herein can be a vegetable fat. The vegetable fat may be palm kern oil (PKO), coconut oil, palm oil, soybean, canola, corn oil, nut butter fat (e.g., almond butter fat and the like), or any combination thereof. The fats can be non-hydrogenated, partially hydrogenated, hydrogenated, or a winterized fraction of the fat. The fat content of the whippable emulsion may be from about 10 to about 30 wt %, from about 15 to about 30 wt %, from about 20 to about 30 wt %, from about 25 to about 30 wt %, from about 10 to about 25 wt %, from about 10 to about 20 wt %, from about 10 to about 15 wt %, from about 15 to about 25 wt %, or from about 20 to about 25 wt %. In one non to about limiting embodiment, the whippable emulsion comprises from about 18 to about 22 wt % fat. In another non-limiting embodiment, the fat may be non-hydrogenated PKO.

d. Stabilizers

A whippable emulsion as described herein may include one or more stabilizers. The stabilizer can include hydrophilic colloids. The one or more stabilizers can be natural stabilizers (e.g., vegetable based stabilizers), synthetic gums (e.g., carrageenan, guar gum, alginate, xanthan gum, and the like), a methylcellulose compound (e.g., Methocel™ A 15 & A 400; carboxy-methylcellulose; hydroxy-propylmethylcellulose (Methocel™ F-50 HG); Methocel™ 50/50 (cellulose ether that includes methylcellulose (MC) and hydroxypropyl methylcellulose (HPMC) polymers), etc.), and/or microcrystalline cellulose. In one non-limiting embodiment, the stabilizer includes a gum or a combination of gums. The whippable emulsion may include stabilizers in an amount that is permissible under FDA guidelines. The whippable emulsion may comprise from about 0 to about 2 wt %, from about 0.01 to about 2 wt %, from about 0.05 to about 2 wt %, from about 0.1 to about 2 wt %, from about 0.01 to about 2 wt %, from about 0.1 to about 2 wt %, from about 0.15 to about 2 wt %, from about 0.2 to about 2 wt %, from about 0.25 to about 2 wt %, from about 0.3 to about 2 wt %, from about 0.35 to about 2 wt %, from about 0.4 to about 2 wt %, from about 0.45 to about 2 wt %, from about 0.5 to about 2 wt %, from about 0.55 to about 2 wt %, from about 0.6 to about 2 wt %, from about 0.65 to about 2 wt %, from about 0.7 to about 2 wt %, from about 0.75 to about 2 wt %, from about 0.8 to about 2 wt %, from about 0.85 to about 2 wt %, from about 0.9 to about 2 wt %, from about 0.95 to about 2 wt %, from about 1 to about 2 wt %, from about 1.05 to about 2 wt %, from about 1.1 to about 2 wt %, from about 1.15 to about 2 wt %, from about 1.2 to about 2 wt %, from about 1.25 to about 2 wt %, from about 1.3 to about 2 wt %, from about 1.35 to about 2 wt %, from about 1.4 to about 2 wt %, from about 1.45 to about 2 wt %, from about 1.5 to about 2 wt %, from about 1.55 to about 2 wt %, from about 1.6 to about 2 wt %, from about 1.65 to about 2 wt %, from about 1.7 to about 2 wt %, from about 1.75 to about 2 wt %, from about 1.8 to about 2 wt %, from about 1.85 to about 2 wt %, from about 1.9 to about 2 wt %, from about 1.95 to about 2 wt %, from about 0 to about 1 wt %, from about 0.01 to about 1 wt %, from about 0.05 to about 1 wt %, from about 0.1 to about 1 wt %, from about 0.15 to about 1 wt %, from about 0.2 to about 1 wt %, from about 0.25 to about 1 wt %, from about 0.3 to about 1 wt %, from about 0.35 to about 1 wt %, from about 0.4 to about 1 wt %, from about 0.45 to about 1 wt %, from about 0.5 to about 1 wt %, from about 0.55 to about 1 wt %, from about 0.6 to about 1 wt %, from about 0.65 to about 1 wt %, from about 0.7 to about 1 wt %, from about 0.75 to about 1 wt %, from about 0.8 to about 1 wt %, from about 0.85 to about 1 wt %, from about 0.9 to about 1 wt %, from about 0.95 to about 1 wt %, from about 0 to about 0.5 wt %, from about 0.01 to about 0.5 wt %, from about 0.05 to about 0.5 wt %, from about 0.1 to about 0.5 wt %, from about 0.15 to about 0.5 wt %, from about 0.2 to about 0.5 wt %, from about 0.25 to about 0.5 wt %, from about 0.3 to about 0.5 wt %, from about 0.35 to about 0.5 wt %, from about 0.4 to about 0.5 wt %, from about 0.45 to about 0.5 wt %, from about 0 to about 0.1 wt %, from about 0.01 to about 0.1 wt %, from about 0.02 to about 0.1 wt %, from about 0.03 to about 0.1 wt %, from about 0.04 to about 0.1 wt %, from about 0.05 to about 0.1 wt %, from about 0.06 to about 0.1 wt %, from about 0.07 to about 0.1 wt %, from about 0.08 to about 0.1 wt %, from about 0.09 to about 0.1 wt %, from about 0.05 to about 1 wt %, or from about 0.06 to about 0.5 wt % of a stabilizer. In one non-limiting embodiment, the stabilizer includes from about 0.02 to about 0.1 wt % gum (e.g., xantham gum, etc.) and from about 0.15 to about 0.9 wt % of a methylcellulose compound (e.g., methylcellulose, carboxy-methylcellulose, hydroxy-propylmethylcellulose, Methocel Tm 50/50, etc.).

e. Emulsifiers

A whippable emulsion as described herein may include one or more emulsifiers. A number of different emulsifiers can be used in amounts on the same order as known in the art of oil-in-water emulsions, as permissible under FDA guidelines. Suitable emulsifiers include lecithin, hydroxylated lecithin; mono-, di-, or polyglycerides of fatty acids, such as stearin and palmitin mono- and diglycerides, polyoxyethylene ethers of fatty esters of polyhydric alcohols, such as the polyoxyethylene ethers of sorbitan monostearate (polysorbate 60), polysorbate 80, or the polyoxyethylene ethers of sorbitan distearate; fatty esters of polyhydric alcohols such as sorbitan monostearate; polyglycerol esters of mono- and diglycerides such as hexaglyceryl distearate; mono- and diesters of glycols such as propylene glycol monostearate, and propylene glycol monopalmitate, succinoylated monoglycerides; and the esters of carboxylic acids such as lactic, citric, and tartaric acids with the mono- and diglycerides of fatty acids such as glycerol lacto palmitate and glycerol lacto stearate, and calcium or sodium stearoyl lactylates and all members of the sucrose ester family thereof, all varieties of diacetyltartaric esters of fatty acids, “DATEMS”, dipotassium hydrogen phosphate (DPHP), and mixtures thereof. The whippable emulsion may comprise from about 0 to about 2 wt %, from about 0.01 to about 2 wt %, from about 0.05 to about 2 wt %, from about 0.1 to about 2 wt %, from about 0.01 to about 2 wt %, from about 0.1 to about 2 wt %, from about 0.15 to about 2 wt %, from about 0.2 to about 2 wt %, from about 0.25 to about 2 wt %, from about 0.3 to about 2 wt %, from about 0.35 to about 2 wt %, from about 0.4 to about 2 wt %, from about 0.45 to about 2 wt %, from about 0.5 to about 2 wt %, from about 0.55 to about 2 wt %, from about 0.6 to about 2 wt %, from about 0.65 to about 2 wt %, from about 0.7 to about 2 wt %, from about 0.75 to about 2 wt %, from about 0.8 to about 2 wt %, from about 0.85 to about 2 wt %, from about 0.9 to about 2 wt %, from about 0.95 to about 2 wt %, from about 1 to about 2 wt %, from about 1.05 to about 2 wt %, from about 1.1 to about 2 wt %, from about 1.15 to about 2 wt %, from about 1.2 to about 2 wt %, from about 1.25 to about 2 wt %, from about 1.3 to about 2 wt %, from about 1.35 to about 2 wt %, from about 1.4 to about 2 wt %, from about 1.45 to about 2 wt %, from about 1.5 to about 2 wt %, from about 1.55 to about 2 wt %, from about 1.6 to about 2 wt %, from about 1.65 to about 2 wt %, from about 1.7 to about 2 wt %, from about 1.75 to about 2 wt %, from about 1.8 to about 2 wt %, from about 1.85 to about 2 wt %, from about 1.9 to about 2 wt %, from about 1.95 to about 2 wt %, from about 0 to about 1 wt %, from about 0.01 to about 1 wt %, from about 0.05 to about 1 wt %, from about 0.1 to about 1 wt %, from about 0.15 to about 1 wt %, from about 0.2 to about 1 wt %, from about 0.25 to about 1 wt %, from about 0.3 to about 1 wt %, from about 0.35 to about 1 wt %, from about 0.4 to about 1 wt %, from about 0.45 to about 1 wt %, from about 0.5 to about 1 wt %, from about 0.55 to about 1 wt %, from about 0.6 to about 1 wt %, from about 0.65 to about 1 wt %, from about 0.7 to about 1 wt %, from about 0.75 to about 1 wt %, from about 0.8 to about 1 wt %, from about 0.85 to about 1 wt %, from about 0.9 to about 1 wt %, from about 0.95 to about 1 wt %, from about 0 to about 0.5 wt %, from about 0.01 to about 0.5 wt %, from about 0.05 to about 0.5 wt %, from about 0.1 to about 0.5 wt %, from about 0.15 to about 0.5 wt %, from about 0.2 to about 0.5 wt %, from about 0.25 to about 0.5 wt %, from about 0.3 to about 0.5 wt %, from about 0.35 to about 0.5 wt %, from about 0.4 to about 0.5 wt %, from about 0.45 to about 0.5 wt %, from about 0 to about 0.1 wt %, from about 0.01 to about 0.1 wt %, from about 0.02 to about 0.1 wt %, from about 0.03 to about 0.1 wt %, from about 0.04 to about 0.1 wt %, from about 0.05 to about 0.1 wt %, from about 0.06 to about 0.1 wt %, from about 0.07 to about 0.1 wt %, from about 0.08 to about 0.1 wt %, from about 0.09 to about 0.1 wt %, from about 0.05 to about 1 wt %, or from about 0.06 to about 0.4 wt % of an emulsifier. In one non-limiting embodiment, the emulsifier includes from about 0.05 to about 0.3 wt % DPHP.

f. Salts

A whippable emulsion as described herein may include salt. The salt can be useful as a buffer, flavoring agent, and/or a preservative. Non-limiting examples of the one or more salts that can be included in the whippable emulsion are sodium chloride, sodium or potassium phosphates, citrates, chlorides, sorbates, and the like. The whippable emulsion may comprise from about 0 to about 0.8 wt %, from about 0.005 to about 0.8 wt %, from about 0.01 to about 0.8 wt %, from about 0.05 to about 0.8 wt %, from about 0.1 to about 0.8 wt %, from about 0.15 to about 0.8 wt %, from about 0.2 to about 0.8 wt %, from about 0.25 to about 0.8 wt %, from about 0.3 to about 0.8 wt %, from about 0.35 to about 0.8 wt %, from about 0.4 to about 0.8 wt %, from about 0.45 to about 0.8 wt %, from about 0.5 to about 0.8 wt %, from about 0.55 to about 0.8 wt %, from about 0.6 to about 0.8 wt %, from about 0.65 to about 0.8 wt %, from about 0.7 to about 0.8 wt %, from about 0.75 to about 0.8 wt %, from about 0 to about 0.4 wt %, from about 0.005 to about 0.4 wt %, from about 0.01 to about 0.4 wt %, from about 0.05 to about 0.4 wt %, from about 0.1 to about 0.4 wt %, from about 0.15 to about 0.4 wt %, from about 0.2 to about 0.4 wt %, from about 0.25 to about 0.4 wt %, from about 0.3 to about 0.4 wt %, from about 0.35 to about 0.4 wt %, from about 0 to about 0.2 wt %, from about 0.005 to about 0.2 wt %, from about 0.01 to about 0.2 wt %, from about 0.05 to about 0.2 wt %, or from about 0.1 to about 0.2 wt % of a salt.

g. Protein

A whippable emulsion as described herein may include one or more types of protein. The one or more proteins that may be present in the whippable emulsion in an amount of at least about 0.1 wt %. The content of the one or more proteins in the whippable emulsion generally does not exceed about 5 wt % (e.g., from about 0.1 to about 5 wt % and all values and ranges there between), typically from about 0.2 to about 2 wt % of the whippable emulsion, and more typically from about 0.5 to about 1.5 wt % of the whippable emulsion. Non-limiting proteins that can be used include milk proteins such as isolated sodium, potassium or calcium caseinates, protein provided as skim milk, nonfat dry milk, milk protein concentrate, whey protein concentrates, alpha lactalbumin and beta lactoglobulin. Vegetable proteins including, but not limited to, soy protein, pea protein, wheat protein, cottonseed protein, peanut protein, and corn protein are also useful. Meat proteins derived as soluble proteins from meat processing may also be used.

h. Other Ingredients

A whippable emulsion as described herein may optionally include one or more other ingredients such as, but not limited to, flavoring agents, coloring agents/colorants, vitamins, minerals, etc. Suitable flavoring agents can be employed to impart various flavors to the whippable emulsion (e.g., vanilla, natural vanilla, cream, chocolate, coffee, maple, spice, mint, butter, caramel, fruit and other flavors). In one non-limiting embodiment, flavorings and/or sweetness inhibitors can be used in the whippable emulsion in amounts of from about 0.001 to about 1 wt % (and all values and ranges therebetween), typically from about 0.01 to about 0.6 wt % of the whippable emulsion, and more typically from about 0.05 to about 0.3 wt % of the whippable emulsion.

TABLE 1 and TABLE 2 provide non-limiting examples of a low-calorie whippable emulsions in accordance with the present disclosure.

TABLE 1
Low-calorie whippable emulsion example embodiment.

| Ingredients | Amount of Ingredient (wt %) |
|---|---|
| Water | From about 40 to about 60 |
| Fat | From about 20 to about 30 |
| Stabilizer | From about 0.05 to about 0.8 |
| Sodium Caseinate | From about 0.1 to about 2 |
| DPHP | From about 0.05 to about 0.4 |
| Non-nutritive natural sweetener | From about 20 to about 40 |
| Sugar Pre-Mix | From about 0 to about 10 |
| Sweetness Inhibitor | From about 0 to about 1 |
| Salt | From about 0 to about 0.4 |
| Flavor | From about 0 to about 1 |
| Total | 100 |

TABLE 2
Low-calorie whippable emulsion example
embodiment comprising sweetener syrup.

| Ingredients | Amount of Ingredient (wt %) |
|---|---|
| Water | From about 40 to about 60 |
| Fat | From about 20 to about 30 |
| Stabilizer | From about 0.05 to about 0.8 |
| Sodium Caseinate | From about 0.1 to about 2 |
| DPHP | From about 0.05 to about 0.4 |
| Non-nutritive natural sweetener syrup | From about 5 to about 40 |
| Mixed Sugar Syrup | From about 0 to about 30 |
| Nutritive sweetener | From about 0 to about 30 |
| Sweetness Inhibitor | From about 0 to about 1 |
| Salt | From about 0 to about 0.4 |
| Flavor | From about 0 to about 1 |
| Total | 100 |

A whippable emulsion as described herein can be stored and distributed in a frozen form or at refrigerated temperatures (from about 32° F. to about 50° F.). The whippable composition can be frozen and stored for up to 365 days before thawing. After freezing and thawing, the whippable composition can be stored in the refrigerator for up to 24 hours before whipping in a mixer or by hand.

### 3. Methods of Making a Whipped Food Product

Provided herein are methods of making a whipped food product comprising a whippable emulsion described herein. The methods may include mixing a nutritive sweetener and other dry ingredients such as sodium caseinate, methocel, salt, dipotassium hydrogen phosphate, xanthan gum, and/or rice extract (i.e. sugar pre-mix); adding the mixture to a fat in a container and mixing; adding hot water (e.g., from about 150° F. to about 185° F., from about 155° F. to about 180° F., from about 160° F. to about 175° F., or from about 165° F. to about 170° F.) and a non-nutritive natural sweetener (e.g., allulose, tagatose, or a combination thereof) to the mixture and heating the mixture; homogenizing the mixture to form an emulsion; cooling the emulsion; and, whipping the emulsion to form a whipped food product.

After freezing and thawing or after cooling the whippable emulsion, the whippable emulsion can be whipped using a stationary mixer or continuous type of Oakes machine. To obtain a whipped food product, the whippable emulsion can be whipped using a paddle, whip, traditional batch mixer (Hobart®, KitchenAid®, Kenwood©, etc.), aeration device including continuous mixers and the like. The whippable emulsion can be whipped to a high percentage overrun of up to about 100%, up to about 150%, up to about 200%, up to about 250%, up to about 300%, up to about 350%, up to about 400%, up to about 450%, or up to about 500%.

The method may further comprise heating the mixture of sugar pre-mix, fat, water and allulose to about 175° F., about 170° F., about 165° F., about 160° F., about 155° F., or about 150° F. The mixture may be heated for about 5 minutes, about 4 minutes, or about 3 minutes.

The mixture may be homogenized in one step or two steps. If the mixture is homogenized in one step, the mixture may be homogenized for a total of about 5,000 PSI, about 5,500 PSI, about 6,000 PSI, about 6,500 PSI, about 7,000 PSI, about 7,500 PSI, about 8,000 PSI, about 8,500 PSI, or about 9,000 PSI. If the mixture is homogenized in two steps, the first step may comprise homogenizing the mixture for about 4,000 PSI, about 4,500 PSI, about 5,000 PSI, about 5,500 PSI, about 6,000 PSI, about 6,500 PSI, about 7,000 PSI, about 7,500 PSI, or about 8,000 PSI; and the second step may comprise homogenizing the mixture for about 200 PSI, about 300 PSI, about 400 PSI, about 500 PSI, about 600 PSI, about 700 PSI, or about 800 PSI. If the mixture is homogenized in two steps, the mixture may be homogenized for a total of about 5,000 PSI, about 5,500 PSI, about 6,000 PSI, about 6,500 PSI, about 7,000 PSI, about 7,500 PSI, about 8,000 PSI, about 8,500 PSI, or about 9,000 PSI.

A variety of whipped food products/confections can be made from a whippable emulsion as described herein. Such confections include fillings, icings, toppings, decorations and the like which can be used for application to cakes, pies, cookies, beverages, and the like.

### 4. Examples

The foregoing may be better understood by reference to the following examples, which are presented for purposes of illustration and are not intended to limit the scope of the invention. The present disclosure has multiple aspects and embodiments, illustrated by the appended non-limiting examples.

### Example 1

Non-Hydrogenated Whippable Topping with Allulose

A low-calorie whippable composition as described herein was prepared using a sugar pre-mix. Sugar and other dry ingredients such as sodium caseinate, methocel, salt, dipotassium hydrogen phosphate, xanthan gum, and/or rice extract were thoroughly blended together to make the sugar pre-mix. The pre-mix was added to non-hydrogenated palm kernel oil (PKO) in a kettle and the contents of the kettle were mixed. Next, warm water (e.g., 165-170° F.) and sugar (e.g., high fructose corn syrup, corn syrup 63/43) were added to the kettle with the premix and non-hydrogenated PKO mixture. The mixture in the kettle was heated to 165° F. and held for about 5 minutes for pasteurization. Flavors were added to the kettle before homogenization and cooling of the mixture. The homogenization was performed in a double stage at 6,500 PSI (first stage) and 500 PSI (second stage), for a total of 7,000 PSI. The resulting homogenized whippable composition was then cooled using a plate or tubular heat exchanger in two stages, during the first stage the composition was cooled to 95-98° F. and during the second stage the composition was cooled to 40-45° F. The cooled whippable composition was packaged in suitable containers and was frozen. The whippable composition can be frozen for up to 365 days before thawing. Two sets of experiments were run. In the first set, three samples were tested (Sample 26A, Sample 26B, and Sample 26C) that contained non-hydrogenated palm kernel oils and three different types of sweeteners: Allulose in Sample 26A, granulated sugar in Sample 26B, and high fructose corn syrup in Sample 26C. A small amount of low intensity corn syrup sweetener was also added in all three samples as a bulking agent. Based on the encouraging performance results obtained with Sample 26A that contained allulose in comparison with Sample 26B (traditional granulated sugar) and Sample 26C (high fructose corn syrup), a second set of experiments was conducted and repeated. Sample 28A contained only Allulose and Samples 28B, 28C, and 28D contained only granulated sugar. The detailed compositions of the formulas for Samples 26A-C and Samples 28A-D are shown in TABLE 3 and TABLE 4, respectively. A summary of performance results for the Sample whippable compositions are set forth in TABLE 5 and TABLE 6.

TABLE 3
Compositions of whip toppings made with allulose sugar,
granulated sugar, or high fructose corn syrup.

| | Amount of Ingredient (wt %) | | |
|---|---|---|---|
| | Sample | Sample | Sample |
| Ingredients | 26A | 26B | 26C |
| Non-Hydrogenated PKO/Coconut oil | 20.0000 | 20.0000 | 20.0000 |
| Corn Syrup 63/43 | 5.0000 | 5.0000 | 5.0000 |
| Allulose Sugar | 25.0000 | 0.0000 | 0.0000 |
| Granulated Sugar | 0.0000 | 20.0000 | 0.0000 |
| High Fructose Corn Syrup (HFCS) | 0.0000 | 0.0000 | 25.3000 |
| Sugar Pre-mix | 0.2000 | 0.2000 | 0.2000 |
| Sodium Stearoyl Lactylate (SSL) | 0.0500 | 0.0000 | 0.0000 |
| Sodium Caseinate | 0.9000 | 0.9000 | 0.9000 |
| Methocel 50/50 | 0.4000 | 0.4000 | 0.4000 |
| Dipotassium hydrogen phosphate | 0.1200 | 0.1200 | 0.1200 |
| (DPHP) | | | |
| Salt | 0.1000 | 0.1000 | 0.1000 |
| Xanthan Gum | 0.0600 | 0.0600 | 0.0600 |
| Gum Arabic | 0.0000 | 0.5000 | 0.0000 |
| Rice Extract | 0.0000 | 0.0000 | 0.1000 |
| Sweetness Inhibitor | 0.0100 | 0.0100 | 0.0100 |
| Flavor Cream | 0.1000 | 0.1000 | 0.1000 |
| Water | 48.0600 | 52.6100 | 47.7100 |
| Total wt % | 100 | 100 | 100 |
| Total Solids, % | 43.74 | 46.44 | 44.00 |

TABLE 4
Compositions of whip toppings made with allulose
sugar or granulated sugar in combination with non-
hydrogenated or hydrogenated palm kernel oil.

| | Amount of Ingredient (wt %) | | | |
|---|---|---|---|---|
| | Sample | Sample | Sample | Sample |
| Ingredients | 28A | 28B | 28C | 28D |
| Non-Hydrogenated PKO | 20.00 | 20.00 | 0.00 | 0.00 |
| Hydrogenated PKO 42 | 0.00 | 0.00 | 24.00 | 24.00 |
| Polysorbate 80 | 0.00 | 0.00 | 0.00 | 0.05 |
| Allulose Sugar | 30.00 | 0.00 | 0.00 | 0.00 |
| Granulated Sugar | 0.00 | 25.00 | 22.00 | 22.00 |
| Sugar Pre-mix | 0.20 | 0.00 | 0.20 | 0.20 |
| Sodium Caseinate | 0.90 | 0.90 | 0.90 | 0.90 |
| Methocel 50/50 | 0.40 | 0.40 | 0.40 | 0.40 |
| Dipotassium hydrogen | 0.12 | 0.00 | 0.12 | 0.12 |
| phosphate (DPHP) | | | | |
| Salt | 0.10 | 0.00 | 0.15 | 0.15 |
| Xanthan Gum | 0.06 | 0.06 | 0.04 | 0.04 |
| Rice Extract | 0.00 | 0.00 | 0.10 | 0.10 |
| Sweetness Inhibitor | 0.01 | 0.00 | 0.01 | 0.01 |
| Natural Vanilla Flavor | 0.00 | 0.02 | 0.00 | 0.00 |
| Flavor Cream | 0.10 | 0.00 | 0.10 | 0.10 |
| Water | 48.11 | 53.62 | 51.98 | 51.93 |
| Total wt % | 100 | 100 | 100 | 100 |
| Total Solids, % | 43.19 | 46.38 | 48.02 | 48.06 |

TABLE 5
Performance of whipped topping using KitchenAid mixer, speed 6.

| | Whip | | Rosette | | | | |
|---|---|---|---|---|---|---|---|
| | Time | % | time | | Immediate Bowl/ | Stability on | Stability in |
| Sample | (min) | Overrun | (min) | Stability | Cake Application | Cake | Bowl |
| 28A | 4:30 | 365 | 30 | Good for | Smooth texture, | Good: no bulging, | No syneresis, no |
| | | | | one week | shiny/glossy | cracking, or | cracking, and slight |
| | | | | | appearance, and | bubbling after 48 | amount air cell |
| | | | | | no air cells. | hours on a cake | coalescence after |
| | | | | | | in refrigeration. | 48 hours of |
| | | | | | | | refrigeration. |
| 28B | 4:30 | 326 | 45 | Good for | Smooth texture, | Good: no bulging, | No syneresis, no |
| | | | | one week | shiny/glossy | cracking, or | cracking, and slight |
| | | | | | appearance, and | bubbling after 48 | amount air cell |
| | | | | | no air cells. | hours on a cake | coalescence after |
| | | | | | | in refrigeration. | 48 hours of |
| | | | | | | | refrigeration. |
| 28C | 6:00 | 391 | 60 | Good for | Smooth texture, | Good: no bulging, | No syneresis, no |
| | | | | more | shiny/glossy | cracking, or | cracking, and no air |
| | | | | than one | appearance, and | bubbling after 48 | cells after 48 hours |
| | | | | week | no air cells. | hours on a cake | of refrigeration. |
| | | | | | | in refrigeration. | |
| 28D | 4:00 | 360 | 60 | Good for | Smooth texture, | Good: no bulging, | No syneresis, no |
| | | | | texture | shiny/glossy | cracking, or | cracking, and slight |
| | | | | | appearance, and | bubbling after 48 | amount air cell |
| | | | | | no air cells. | hours on a cake | coalescence after |
| | | | | | | in refrigeration. | 48 hours of |

Note:
An indication of “good” means that whipped product had no air coalescence, no syneresis (water separation), or no bulging or no bubbling.

TABLE 6
Performance of whipped topping using Hobart mixer, speed 2 (medium speed).

| | Whip | | | Rosette | | | |
|---|---|---|---|---|---|---|---|
| | Time | % | Penetrometer | time | Immediate Bowl/ | Stability on | Stability in |
| Sample | (min) | Overrun | (mm) | (min) | Cake Application | Cake | Bowl |
| 28A | 8:22 | 399 | 34.7 | 20-30 | Gritty and small | Good: no bulging, | Slight-moderate |
| | | | | | pocks texture, semi | cracking, or | syneresis, no |
| | | | | | dull appearance, no | bubbling after 14 | cracking, and |
| | | | | | air cells, firm, sticky, | days on a cake in | no air cells after |
| | | | | | and smooth | refrigeration. | 14 days of |
| | | | | | spreading. | | refrigeration. |
| 28B | 8:06 | 387 | 35.1 | 60-70 | Fine grain texture, | Good: no bulging, | No syneresis, |
| | | | | | semi dull | cracking, or | no cracking, |
| | | | | | appearance, no air | bubbling after 14 | and no air cells |
| | | | | | cells, firm, sticky, | days on a cake in | after 14 days of |
| | | | | | and smooth | refrigeration. | refrigeration. |
| | | | | | spreading. | | |
| 28C | 12:46 | 459 | 38.4 | 90+ | Fine grain texture, | Good: no bulging, | No syneresis, |
| | | | | | soft sheen | cracking, or | no cracking, |
| | | | | | appearance, no air | bubbling after 14 | and no air cells |
| | | | | | cells, soft-firm, | days on a cake in | after 14 days of |
| | | | | | sticky, and smooth | refrigeration. | refrigeration. |
| | | | | | spreading. | | |
| 28D | 7:36 | 380 | 35.0 | 80-90 | | Good: no bulging, | No syneresis, |
| | | | | | | cracking, or | no cracking, |
| | | | | | | bubbling after 14 | and no air cells |
| | | | | | | days on a cake in | after 14 days of |
| | | | | | | refrigeration. | refrigeration. |

Note:
An indication of “good” means that whipped product had no air coalescence, no syneresis (water separation), or no bulging or no bubbling.

The whippable composition made with allulose provides fewer calories per serving and is therefore desirable for calorie conscious individuals. Sample A made with allulose was stable on a cake and in a bowl, and also provided a smooth, firm texture and mouthfeel that was similar to regular whipped toppings made with granulated sugar. The whippable composition made with allulose, when whipped, demonstrated good stability on a cake with no cracking, bubbling, or bulging after 24 hours and 48 hours. Similarly, whippable compositions made with allulose, when whipped, showed good stability in a bowl with no syneresis, cracking or air cell coalescence after 24 hours, and showed only slight cracking and slight air cell coalescence in the bowl after 48 hours.

The whippable composition made with allulose, when whipped, demonstrated a good overrun percentage and stability when used for decorating a cake or when stored in a bowl overnight. The whippable composition made with allulose, when whipped, was found to be stable on a decorated cake and in a bowl at refrigerated temperature for up to 7 days and 6 months or longer when frozen.

### Example 2

Whippable Topping with Allulose Syrup

In this study, the use of allulose as a sugar replacement in whipped topping compositions was tested. Four whippable emulsion compositions were batched, whipped, and evaluated at a bench scale using various sugar systems. A control formulation was compared to three experimental formulations, each containing different levels of allulose, a rare sugar with a clean taste and 70% less calories than table sugar. The comparisons were based on batching feasibility, performance evaluations, and analytical evaluations. Results from this study indicated that replacing HFCS with appropriate amounts of allulose led to no negative effects on product performance. Therefore, the utilization of allulose in product development may allow for formulas with great performance but with fewer calories and fewer added sugars than their traditional counterparts. Further testing on different formulas will be conducted to test these new ingredients in other emulsion-based products such as icings like icings that do not require storage under refrigeration, cooking creams, coffee creamers, and the like.

Current restrictions on the use of allulose in confectionary toppings limit allulose content to a maximum of 5%. Therefore, one component of these experiments was to limit allulose presence in sample formulas to 5%. Four sample formulas were developed for testing: Sample 1187-24A (control), Sample 1213-A (contains 5% allulose provided by using 20% Mixed Sugar Syrup (MSS) from Tate & Lyle that contains a mixture of fructose, dextrose, and allulose to directly replace 20% of HFCS in the control formula), Sample 1213-B (MSS fully replaced HFCS in the control formula), and Sample 1213-C(5% pure allulose syrup directly replaced 5% of HFCS in the control formula). Sample 1213-B was not restricted to 5% allulose for experimental purposes. The detailed compositions of the Sample formulas are shown in TABLE 7.

TABLE 7
Compositions of whip toppings made with HFCS, MSS,
pure allulose syrup, or combinations thereof.

| | Amount of Ingredient (wt %) | | | |
|---|---|---|---|---|
| Ingredients | 1187-24A | 1213-A | 1213-B | 1213-C |
| Non-Hydrogenated PKO 42 | 24.50 | 24.50 | 24.50 | 24.50 |
| Allulose Syrup | 0.00 | 0.00 | 0.00 | 5.00 |
| High Fructose Corn Syrup | 28.20 | 8.20 | 0.00 | 23.20 |
| (HFCS) | | | | |
| Mixed Sugar Syrup (MSS) | 0.00 | 20.00 | 28.20 | 0.00 |
| Sugar | 0.80 | 0.80 | 0.80 | 0.80 |
| Sodium Stearoyl Lactylate | 0.46 | 0.46 | 0.46 | 0.46 |
| (SSL) | | | | |
| Sodium Caseinate | 0.60 | 0.60 | 0.60 | 0.60 |
| Methocel 50/50 | 0.40 | 0.40 | 0.40 | 0.40 |
| Dipotassium hydrogen | 0.12 | 0.12 | 0.12 | 0.12 |
| phosphate (DPHP) | | | | |
| Salt | 0.10 | 0.10 | 0.10 | 0.10 |
| Sweetness Inhibitor | 0.01 | 0.01 | 0.01 | 0.01 |
| Flavor Cream | 0.06 | 0.06 | 0.06 | 0.06 |
| Water | 44.75 | 44.75 | 44.75 | 44.75 |
| Total wt % | 100 | 100 | 100 | 100 |
| Total Solids, % | 56.65 | 48.35 | 50.02 | 53.69 |
| Total fat, wt % | 37.38 | 24.63 | 27.36 | 31.94 |

Each formula was batched on a Mini-Niro Homogenization System using the same batching instructions as the control formula. The batching instructions were as follows: non-hydrogenated PKO was placed in a kettle, a pre-mix of dry ingredients such as sodium caseinate, methocel, salt, and/or dipotassium hydrogen phosphate were thoroughly blended together to make the pre-mix and was mixed well with the hydrogenated PKO; hot water (165-170° F.) was added to the kettle; sugar, or HFCS and corn syrup 63/43 was added to the kettle; the contents of the kettle were heated up to 165° F. for 5 minutes; flavors were added to the kettle; the contents of the kettle were homogenized at 6500 PSI/500 PSI for a total of 7000 PSI; the mixture was chilled through a plate heat exchanger to 95-98° F. and to 40-45° F.; 7 kg was batched for each formula; and, the product for each formula was collected and frozen overnight. The frozen product was thawed for 24 hours. The fully thawed product was evaluated after whipping on a bench-top 5 qt. Hobart mixer at speed 2. Evaluations included: cup weight and penetrometer, fats and solids, rosette time, bowl stability, and cake stability.

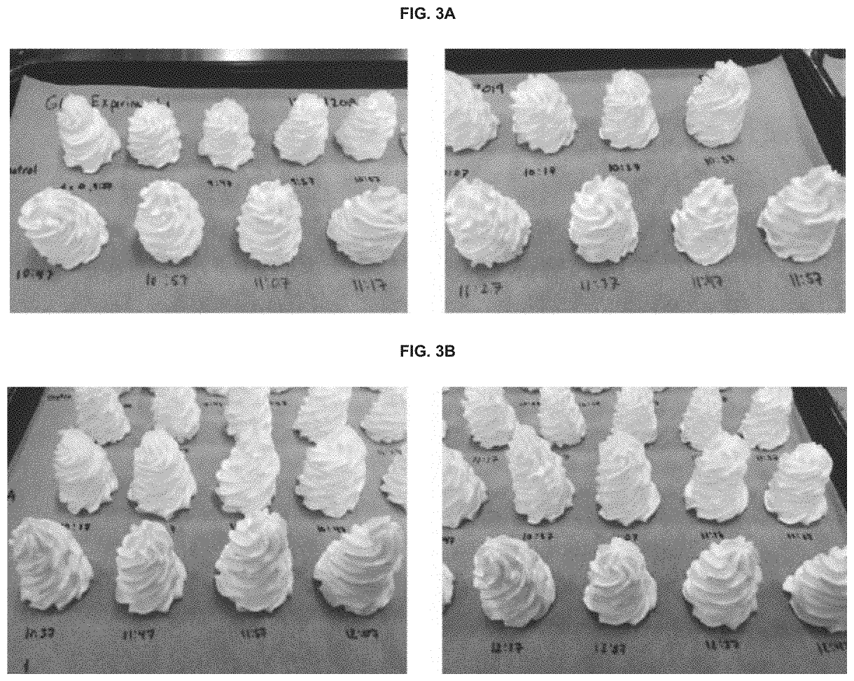

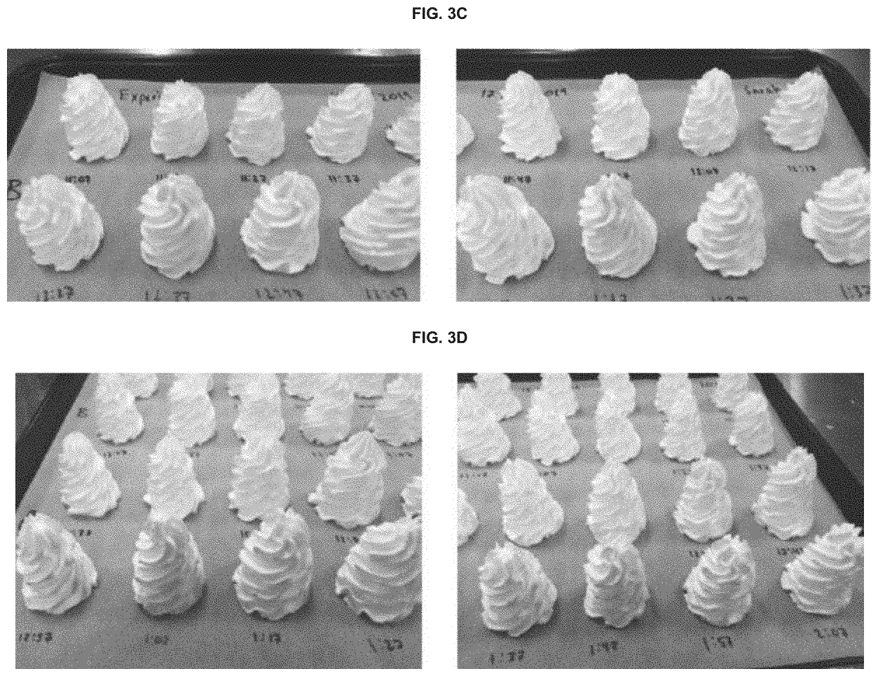

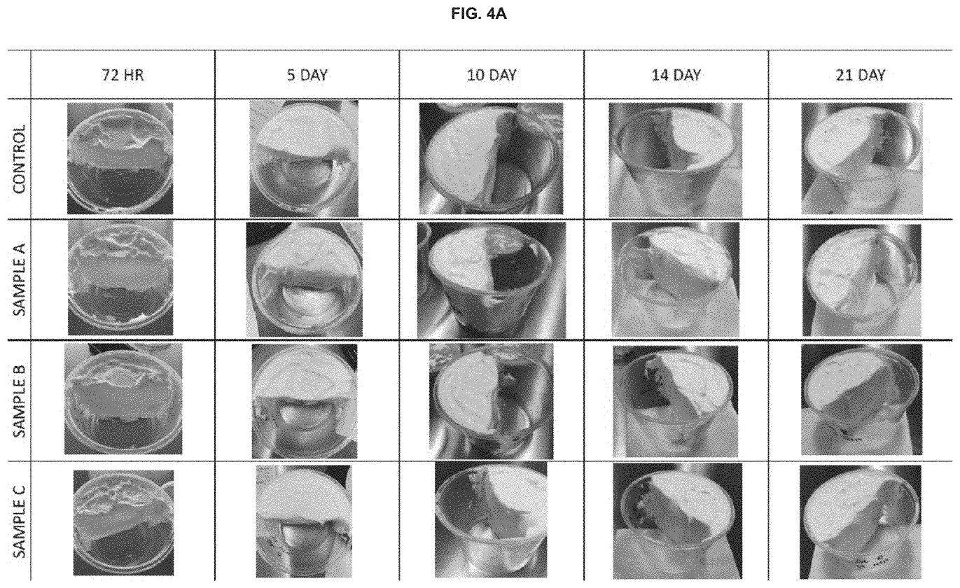

The cup weight was measured in a 100 g cup to determine the amount of air being incorporated into the whipped product. This was compared to the control and used to measure the overrun of each sample. The penetrometer was used as a method to measure the firmness of each sample. The fats and solids for each sample were measured on a CEM compositional analyzer. Rosettes were made for each whipped sample from 0 to 120 minutes, with a rosette completed at 10-minute intervals. Rosettes were evaluated based on quality for a determined “Room Temp Rosette Time”. If rosettes appeared to have excessive cracking, rough edges, or air cell coalescence, then that time was the last acceptable rosette time. For bowl stability small, clear bowls were halfway filled with whipped product. Bowls were kept in a cooler for a 21-day period and evaluated at intervals of 0 hours, 24 hours, 48 hours, 72 hours, 5 days, 10 days, 14 days, and 21 days for signs of syneresis, cracking, and air cell coalescence. If any of these aspects were unacceptable, they failed bowl testing at that time interval. Cake stability was measured using small, clear 2-layer cakes that were assembled using layers of the sample whipped toppings between and around the cake layers. Cakes were decorated with small red rosettes using red food color and the same whipped topping was used for layering. Cakes were kept in a cooler for a 14-day period and evaluated at intervals of 0 hours, 24 hours, 48 hours, 72 hours, 5 days, 10 days, and 14 days for signs of bulging, cracking, bubbling, and color bleed. If any of these aspects were unacceptable, they failed bowl testing at that time interval. Sensory attributes such as flavor and texture were tested for the Samples on Day 1 after being whipped. The performance of the whipped topping samples is shown in TABLEs 8-12 and FIGS. 3-5.

TABLE 8
Performance of whipped toppings using Hobart mixer, speed 2 (medium speed).

| | | | Whip | | | Rosette | |
|---|---|---|---|---|---|---|---|
| | | Water | Time | % | Penetrometer | time | |
| Sample | pH | Activity | (min) | Overrun | (mm) | (min) | Immediate Bowl/Cake Application |
| 1187-24A | 6.38 | 0.942 | 15:01 | 489 | 38.1 | 60-70 | Smooth/fine grain, soft sheen, no air |
| (control) | | | | | | | cells, firm, sticky, and smooth spreading. |
| 1213-A | 6.58 | 0.941 | 16:44 | 501 | 40.3 | 70 | Smooth/fine grain, semi-glossy/soft |
| | | | | | | | sheen, no air cells, firm, sticky, and |
| | | | | | | | smooth spreading, softer edges on |
| | | | | | | | rosettes than control. |
| 1213-B | 6.30 | 0.947 | 16:04 | 502 | 39.7 | 90 | Smooth/fine grain, semi-glossy/soft |
| | | | | | | | sheen, no air cells, firm, sticky, and |
| | | | | | | | smooth spreading, good smooth edges |
| | | | | | | | on rosettes, air cell coalescence started |
| | | | | | | | at 50 min but edges good until 100 min. |
| 1213-C | 6.50 | 0.944 | 12:17 | 471 | 38.8 | 70 | Smooth/fine grain, semi-glossy/soft |
| | | | | | | | sheen, no air cells, firm, sticky, and |
| | | | | | | | smooth spreading, softer edges on |
| | | | | | | | rosettes than control. |

TABLE 9
Stability of 1187-24A (control) whipped topping on cake and in bowl.

| | | Time Under Refrigeration | | | | | | |
|---|---|---|---|---|---|---|---|---|
| | Attributes | 24 hours | 48 hours | 72 hours | 5 days | 10 days | 14 days | 21 days |
| On Cake | Bulging | Firm | Firm | Firm | Firm | Slightly | Slightly | |
| | | walls | walls | walls | walls | soft | soft | |
| | Cracking | None | None/ | Slight | Moderate | Moderate | Moderate/ | |
| | | | Slight | | | | Great | |
| | Bubbling | None | None/ | Slight | Slight | Moderate/ | Moderate/ | |
| | | | Slight | | | Great | Great | |
| | Color Bleed | 1-2 | 1-5 | 1-5 | 1-5 | 5-10 | 10-15 | |
| | (mm) | | | | | | | |
| In Bowl | Cracking | None | None | None | None | None | Slight/ | Moderate |
| | | | | | | | Moderate | |
| | Air Cell | None | None | None | None | None | None/ | Slight |
| | Coalescence | | | | | | Slight | |
| | Syneresis | None | None | None | None | None | None | None/ |
| | | | | | | | | Slight |

TABLE 10
Stability of 1213-A whipped topping on cake and in bowl.

| | | Time Under Refrigeration | | | | | | |
|---|---|---|---|---|---|---|---|---|
| | Attributes | 24 hours | 48 hours | 72 hours | 5 days | 10 days | 14 days | 21 days |
| On Cake | Bulging | Firm | Firm | Firm | Slightly | Slightly | Slightly | |
| | | walls | walls | walls | soft/Soft | soft/Soft | soft/Soft | |
| | Cracking | None | None | None | None/ | None/ | Moderate | |
| | | | | | Slight | Slight | | |
| | Bubbling | None | Slight | Slight | Moderate | Moderate/ | Moderate/ | |
| | | | | | | Great | Great | |
| | Color Bleed | 1-2 | 1-5 | 1-5 | 1-5 | 5-10 | 10-15 | |
| | (mm) | | | | | | | |
| In Bowl | Cracking | None | None | None | None | None | None | None |
| | Air Cell | None | None | None | None | None | None/ | None/ |
| | Coalescence | | | | | | Slight | Slight |
| | Syneresis | None | None | None | None | None/ | None/ | Slight |
| | | | | | | Slight | Slight | |

TABLE 11
Stability of 1213-B whipped topping on cake and in bowl.

| | | Time Under Refrigeration | | | | | | |
|---|---|---|---|---|---|---|---|---|
| | Attributes | 24 hours | 48 hours | 72 hours | 5 days | 10 days | 14 days | 21 days |
| On Cake | Bulging | Firm | Firm | Firm | Slightly | Slightly | Slightly | |
| | | walls | walls | walls | soft | soft | soft | |
| | Cracking | None | None/ | None/ | Slight | Slight/ | Slight/ | |
| | | | Slight | Slight | | Moderate | Moderate | |
| | Bubbling | None | Slight | Slight | Moderate | Moderate | Moderate | |
| | Color Bleed | 1-2 | 1-5 | 1-5 | 1-5 | 5-10 | 10-15 | |
| | (mm) | | | | | | | |
| In Bowl | Cracking | None | None | None | None | None | None | None |
| | Air Cell | None | None | None | None | None | None/ | None/ |
| | Coalescence | | | | | | Slight | Slight |
| | Syneresis | None | None | None | None | None | None | Slight |

TABLE 12
Stability of 1213-C whipped topping on cake and in bowl.

| | | Time Under Refrigeration | | | | | | |
|---|---|---|---|---|---|---|---|---|
| | Attributes | 24 hours | 48 hours | 72 hours | 5 days | 10 days | 14 days | 21 days |
| On Cake | Bulging | Firm | Firm | Firm | Firm walls/ | Firm walls/ | Firm walls/ | |
| | | walls | walls | walls | Slightly | Slightly | Slightly | |
| | | | | | soft | soft | soft | |
| | Cracking | None | None | None | Slight | Slight | Slight/ | |
| | | | | | | | Moderate | |
| | Bubbling | None | None/ | None/ | Slight | Slight | Slight | |
| | | | Slight | Slight | | | | |
| | Color Bleed | 1-2 | 1-5 | 1-5 | 1-5 | 5-10 | 10-15 | |
| | (mm) | | | | | | | |
| In Bowl | Cracking | None | None | None | None | None | None | None |
| | Air Cell | None | None | None | None | None | None/ | None/ |
| | Coalescence | | | | | | Slight | Slight |
| | Syneresis | None | None | None | None | None/ | None/ | Slight |
| | | | | | | Slight | Slight | |

Rosette time testing showed that the control had a rosette time of approximately 60-70 minutes, Samples 1213-A and 1213-C had rosette times of 70 minutes, and Sample 1213-B had a rosette time of 90 minutes. Therefore, Samples 1213-A and 1213-C performed similarly to the control, and Sample 1213-B outperformed the control (FIG. 3A-D).

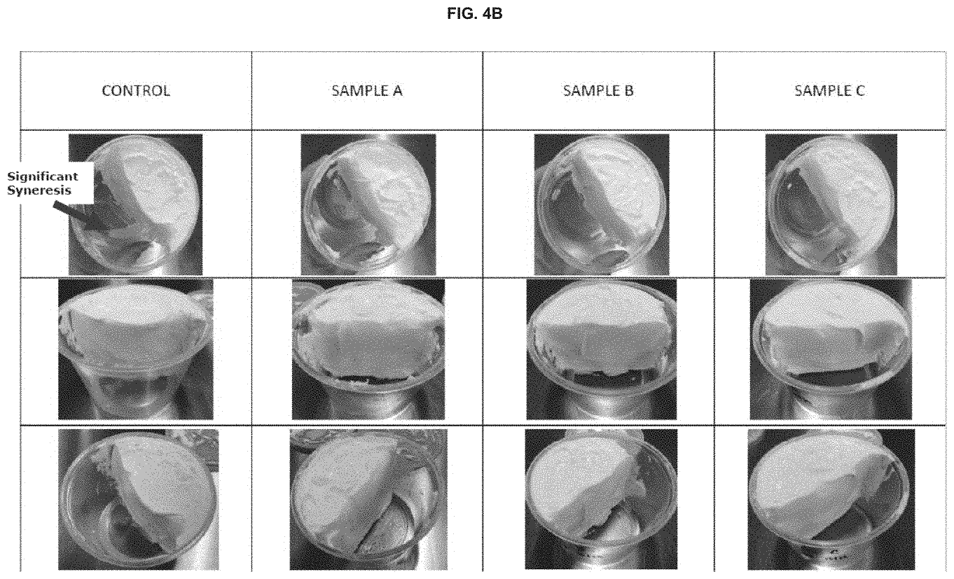

Bowl stability testing showed that the control consistently had firmer walls inside the bowl than the experimental samples (1213-A, 1213-B, and 1213-C). The experimental samples became glossier over time. The syneresis, cracking, and air cell coalescence within the bowls were consistent between samples (FIG. 4A). Requirements for bowl stability testing only go through 21 days. These samples were kept for 35 days for further evaluations. At 35 days, there was significantly more syneresis present in the control than in any of the other 3 samples. Small amounts of syneresis were present in the other 3 samples, but it was insignificant when compared to the control (FIG. 4B).

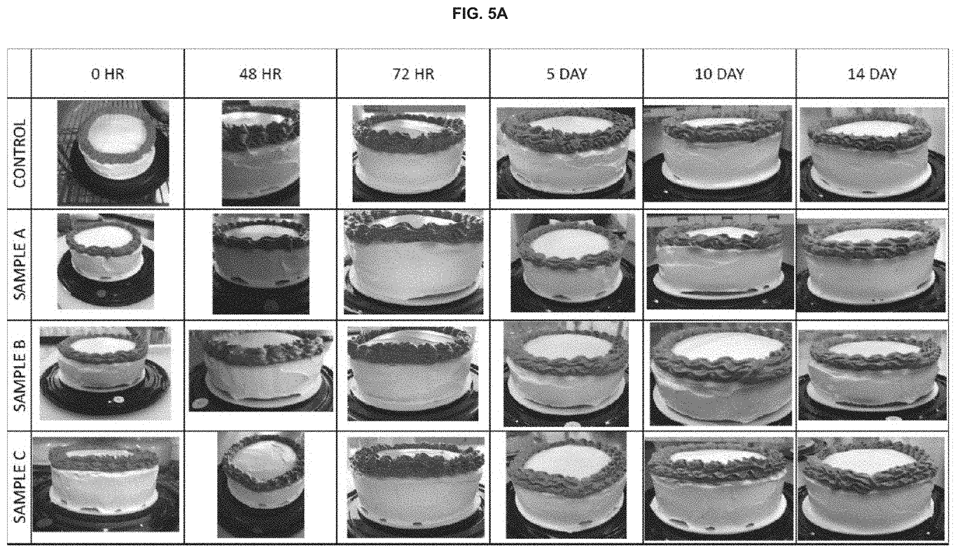

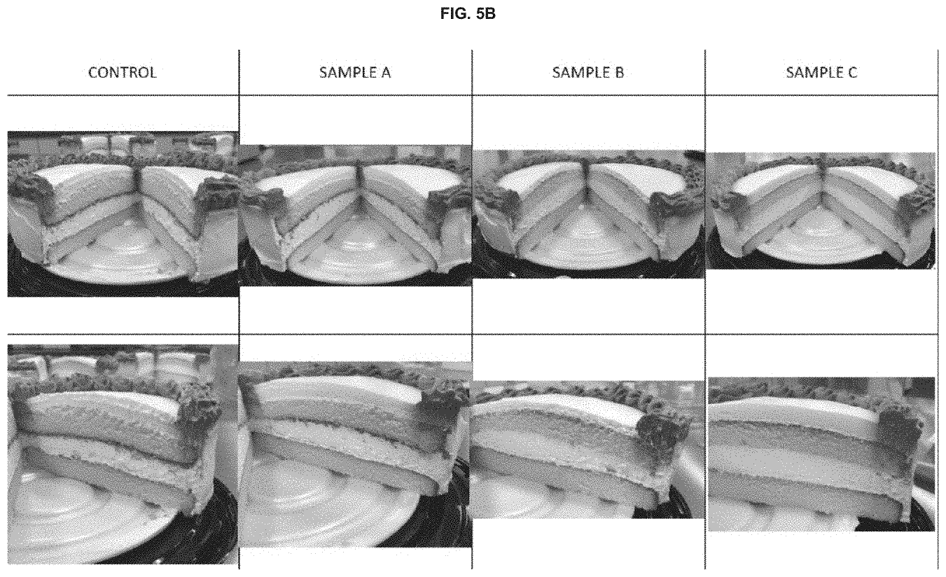

The performance of the whipped topping samples on cakes were relatively similar. Sample 1213-C performed the best out of the samples because the topping had less bulging and less bubbling than the other samples. Differences, however, were not major. The better performance for C may be due to the sample containing the most similar amount of HFCS as the control compared to the other experimental samples. The experimental samples had slightly more bulging over time when compared to the control (FIG. 5A). All samples had surface bubbling on the top of the cake surface and some cracking on the sides near the top surface. Color bleed was the same for each sample (FIG. 5B).

No taste difference was detected between the control and the samples containing allulose.

From a nutrient standpoint, the majority of differences stem from the sugar call-out on the nutrition facts label. The total sugars are lower for each of the experimental samples when compared to the control. More importantly, the “Added Sugar” call-out drops from 20.7 g to 6.7 g for Sample 1213-A, to 1.0 g for Sample 1213-B, and to 17.2 g for Sample 1213-C. This is largely because allulose does not count as part of the Added Sugar total. As a result of the sugar reduction, total calories in a 100 g serving were reduced by about 10-15 g for each of the experimental samples. TABLE 13 shows all of the nutritional facts, the italicized rows show the most significant differences between the control sample and the experimental samples.

TABLE 13
Nutritional facts of whippable emulsions.

| | Sample | | | |
|---|---|---|---|---|
| | 1187-24A (Control) | 1213-A | 1213-B | 1213-C |
| Calories | 311.986 | 299.106 | 293.825 | 299.166 |
| Total Carb (g) | 21.568 | 21.568 | 21.568 | 21.568 |
| Dietary Fiber (g) | 0.382 | 0.382 | 0.382 | 0.382 |
| Sugars (g) | 20.664 | 17.344 | 15.983 | 17.184 |
| Added Sugars (g) | 20.663 | 6.743 | 1.036 | 17.183 |
| Sodium (g) | 0.070 | 0.069 | 0.069 | 0.070 |
| Total Fat (g) | 24.845 | 24.845 | 24.845 | 24.845 |
| Sat Fat (g) | 24.696 | 24.696 | 24.696 | 24.696 |
| Trans Fat (g) | 0.229 | 0.229 | 0.229 | 0.229 |
| Protein (g) | 0.552 | 0.552 | 0.552 | 0.552 |
| Cholesterol (g) | 0.008 | 0.008 | 0.008 | 0.008 |
| Ash (g) | 0.283 | 0.283 | 0.283 | 0.283 |
| Water (g) | 52.964 | 52.984 | 52.992 | 52.969 |
| Potassium (g) | 0.075 | 0.074 | 0.074 | 0.075 |
| Calcium (g) | 0.013 | 0.013 | 0.013 | 0.013 |
| Iron (g) | 0.008 | 0.008 | 0.008 | 0.008 |

In the foregoing experiments, the experimental samples performed similarly to the control sample. There was little visible difference in the 21-day bowl stability testing, with the most difference being between the samples with MSS as a replacement for HFCS. This may be due to the greater difference in HFCS presence between the control and the MSS samples than compared to the 5% allulose sample. However, by day 35 (not within standard of testing timeline), there was a much greater amount of syneresis found in the control than in any of the experimental samples. Overall, this experiment shows promise to replacing some of the HFCS in toppings with allulose sugar to reduce calories and added sugars. More experiments will be executed to continue to evaluate this new ingredient in other formulas and food products.

The foregoing description of the specific aspects will so fully reveal the general nature of the invention that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects, but should be defined only in accordance with the following claims and their equivalents.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

For reasons of completeness, various aspects of the invention are set out in the following numbered clauses:

Clause 1. A whippable emulsion comprising: a non-nutritive natural sweetener; and, a fat.

Clause 2. The whippable emulsion of clause 1, wherein the non-nutritive natural sweetener comprises allulose, tagatose, or a combination thereof.

Clause 3. The whippable emulsion of clause 1, wherein the emulsion further comprises water, a stabilizer, an emulsifier, salt, a protein, and a nutritive sweetener.

Clause 4. The whippable emulsion of clause 1, wherein the emulsion comprises at least about 30 wt % allulose.

Clause 5. The whippable emulsion of any one of the preceding clauses, wherein the emulsion comprises from about 10 to about 30 wt % of the fat.

Clause 6. The whippable emulsion of any one of the preceding clauses, wherein the fat is a non-hydrogenated oil, a hydrogenated oil, or a combination thereof.

Clause 7. The whippable emulsion of clause 6, wherein the non-hydrogenated oil and the hydrogenated oil are vegetable oils.

Clause 8. The whippable emulsion of clause 7, wherein the vegetable oil is palm kernel oil, palm oil, coconut oil, soybean, canola, nut butter fat, corn oil, or a combination thereof.

Clause 9. The whippable emulsion of any one of clauses 2-8, wherein the emulsion comprises from about 40 to about 55 wt % water.

Clause 10. The whippable emulsion of any one of clauses 2-9, wherein the emulsion comprises from about 0.05 to about 0.8 wt % of the stabilizer.

Clause 11. The whippable emulsion of any one of clauses 2-10, wherein the stabilizer is selected from a group consisting of xantham gum, Methocel™ 50/50, and a combination thereof.

Clause 12. The whippable emulsion of any one of clauses 2-11, wherein the emulsion comprises from about 0.1 to about 2 wt % of the protein.

Clause 13. The whippable emulsion of any one of clauses 2-12, wherein the protein is sodium caseinate.

Clause 14. The whippable emulsion of any one of clauses 2-13, wherein the emulsion comprises less than about 20% of the nutritive sweetener.

Clause 15. The whippable emulsion of any one of clauses 2-14, wherein the nutritive sweetener is selected from the group consisting of granulated sugar, high-fructose corn syrup, corn syrup, lactose, maltose, sugar alcohol, sucrose, fructose, and dextrose.

Clause 16. The whippable emulsion of any one of the preceding clauses, wherein the emulsion further comprises a sweetness inhibitor.

Clause 17. The whippable emulsion of any one of the preceding clauses, wherein the emulsion further comprises a flavoring agent.

Clause 18. The whippable emulsion of any one of the preceding clauses, wherein the emulsion further comprises a coloring agent.

Clause 19. A whippable emulsion comprising: at least about 30 wt % of a non-nutritive natural sweetener; from about 10 to about 25 wt % fat; from about 40 to about 55 wt % water; from about 0.05 to about 0.8 wt % stabilizer; from about 0.1 to about 2 wt % protein; less than about 10% of a nutritive sweetener; an emulsifier; salt; a sweetness inhibitor; and, a flavoring agent.

Clause 20. A method for making a whipped food product comprising: (a) mixing a nutritive sweetener and one or more of sodium caseinate, methocel, salt, dipotassium hydrogen phosphate, xanthan gum, and rice extract; (b) adding the mixture of (a) to a fat and mixing; (c) adding from about 165° F. to about 170° F. water and a non-nutritive natural sweetener to the mixture of (b) and heating the mixture; (d) homogenizing the mixture of (c) to form an emulsion; (e) cooling the emulsion of (d); and, (g) whipping the emulsion of (e) to form a whipped food product.

Clause 21. The method of clause 20, wherein the mixture of (c) is heated to about 165° F.

Clause 22. The method of clause 20 or 21, wherein the mixture is homogenized in one step or two steps.

Clause 23. The method of clause 22, wherein the mixture is homogenized at 6,500 PSI and then 500 PSI.

Clause 24. The method of clause 22, wherein the mixture is homogenized at 7,000 PSI.

Clause 25. The method of any one of clauses 20-24, wherein the emulsion comprises: at least about 30 wt % of a non-nutritive natural sweetener; from about 10 to about 25 wt % fat; from about 40 to about 55 wt % water; from about 0.05 to about 0.8 wt % stabilizer; from about 0.1 to about 2 wt % protein; less than about 10% of a nutritive sweetener; an emulsifier; salt; a sweetness inhibitor; and, a flavoring agent.

Clause 26. The method of any one of clauses 20-25, wherein the emulsion is an oil-in-water emulsion.

What is claimed is:

1. A whippable emulsion comprising:
a non-nutritive natural sweetener; and,
a fat.

2. The whippable emulsion of claim 1, wherein the non-nutritive natural sweetener comprises allulose, tagatose, or a combination thereof.

3. The whippable emulsion of claim 1, wherein the emulsion further comprises water, a stabilizer, an emulsifier, salt, a protein, and a nutritive sweetener.

4. The whippable emulsion of claim 1, wherein the emulsion comprises at least about 30 wt % allulose.

5. The whippable emulsion of claim 1, wherein the emulsion comprises from about 10 to about 30 wt % of the fat.

6. The whippable emulsion of claim 1, wherein the fat is a non-hydrogenated oil, a hydrogenated oil, or a combination thereof.

7. The whippable emulsion of claim 6, wherein the non-hydrogenated oil and the hydrogenated oil are vegetable oils.

8. The whippable emulsion of claim 7, wherein the vegetable oil is palm kernel oil, palm oil, coconut oil, soybean, canola, nut butter fat, corn oil, or a combination thereof.

9. The whippable emulsion of claim 3, wherein the emulsion comprises from about 40 to about 55 wt % water.

10. The whippable emulsion of claim 3, wherein the emulsion comprises from about 0.05 to about 0.8 wt % of the stabilizer.

11. The whippable emulsion of claim 3, wherein the stabilizer is selected from a group consisting of xantham gum, Methocel™ 50/50, and a combination thereof.

12. The whippable emulsion of claim 3, wherein the emulsion comprises from about 0.1 to about 2 wt % of the protein.

13. The whippable emulsion of claim 3, wherein the protein is sodium caseinate.

14. The whippable emulsion of claim 3, wherein the emulsion comprises less than about 20% of the nutritive sweetener.

15. The whippable emulsion of claim 3, wherein the nutritive sweetener is selected from the group consisting of granulated sugar, high-fructose corn syrup, corn syrup, lactose, maltose, sugar alcohol, sucrose, fructose, and dextrose.

16. The whippable emulsion of claim 1, wherein the emulsion further comprises a sweetness inhibitor.

17. The whippable emulsion of claim 1, wherein the emulsion further comprises a flavoring agent.

18. The whippable emulsion of claim 1, wherein the emulsion further comprises a coloring agent.

19. A whippable emulsion comprising:
at least about 30 wt % of a non-nutritive natural sweetener;
from about 10 to about 25 wt % fat;
from about 40 to about 55 wt % water;
from about 0.05 to about 0.8 wt % stabilizer;
from about 0.1 to about 2 wt % protein;
less than about 10% of a nutritive sweetener;
an emulsifier;
salt;
a sweetness inhibitor; and,
a flavoring agent.

20. A method for making a whipped food product comprising:
(a) mixing a nutritive sweetener and one or more of sodium caseinate, methocel, salt, dipotassium hydrogen phosphate, xanthan gum, and rice extract;
(b) adding the mixture of (a) to a fat and mixing;
(c) adding from about 165° F. to about 170° F. water and a non-nutritive natural sweetener to the mixture of (b) and heating the mixture;
(d) homogenizing the mixture of (c) to form an emulsion;
(e) cooling the emulsion of (d); and,
(g) whipping the emulsion of (e) to form a whipped food product.

21. The method of claim 20, wherein the mixture of (c) is heated to about 165° F.

22. The method of claim 20, wherein the mixture is homogenized in one step or two steps.

23. The method of claim 22, wherein the mixture is homogenized at 6,500 PSI and then 500 PSI.

24. The method of claim 22, wherein the mixture is homogenized at 7,000 PSI.

25. The method of claim 20, wherein the emulsion comprises:
at least about 30 wt % of a non-nutritive natural sweetener;
from about 10 to about 25 wt % fat;
from about 40 to about 55 wt % water;
from about 0.05 to about 0.8 wt % stabilizer;
from about 0.1 to about 2 wt % protein;
less than about 10% of a nutritive sweetener;
an emulsifier;
salt;
a sweetness inhibitor; and,
a flavoring agent.

26. The method of claim 20, wherein the emulsion is an oil-in-water emulsion.
